(19) United States
(12) Patent Application Publication
(10) Pub. No.: US 2008/0118716 A1
(43) Pub. Date: May 22, 2008

(54) Recording liquid, recording method and recording liquid cartridge

(75) Inventors: Teruki Kawakami, Kanagawa (JP); Katsuya Tanba, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 11/985,968

(22) Filed: Nov. 19, 2007

(30) Foreign Application Priority Data
Nov. 22, 2006 (JP) P2006-316160

(51) Int. Cl. B41M 5/03; C09D 11/00

(52) U.S. Cl. 428/195.1; 106/31.6; 106/31.9

(57) ABSTRACT

A recording liquid is disclosed. The recording liquid contains a pigment; a solvent for dissolving or dispersing this pigment therein and containing water and a water-soluble organic solvent; a water-soluble resin containing a sulfonated isoprene resin and an acrylic resin; and a surfactant containing a polyoxyethylene alkyl phenyl ether and/or a sulfuric ester salt thereof.

### CROSS REFERENCES TO RELATED APPLICATIONS

The present invention contains subjects related to Japanese Patent Application JP 2006-316160 filed in the Japan Patent Office on Nov. 22, 2006, the entire contents of which being incorporated herein by reference.

### BACKGROUND OF THE INVENTION

1. Field of the Invention

The present invention relates to a recording liquid which is used in recording an image or letters on a medium to be recorded, a recording liquid cartridge and a recording method using this recording liquid.

2. Description of the Related Art

A recording method for performing recording by discharging a recording liquid in a droplet state includes an inkjet recording system for discharging an ink as a recording liquid and recording an image or letters. The inkjet recording system is a system in which an ink is discharged in a fine droplet state on a medium to be recorded such as papers, cloths and films from a nozzle of an inkjet head provided in a printer device, thereby printing letters or an image or the like on the medium to be recorded. As a discharging method of an ink of this inkjet recording system, various systems such as a so-called charge control system in which an ink is discharged by utilizing an electrostatic induction force, a system in which an ink is discharged by utilizing a vibration pressure of a piezoelectric element and a so-called thermal inkjet system in which an ink is discharged by utilizing a pressure generated by forming an air bubble by heat and allowing it to grow are employed. According to the inkjet recording system, fine ink droplets can be discharged, and an image or letters with extremely high definition can be printed by employing such an ink discharge system.

A water-soluble ink containing a water-soluble dye is used in such an inkjet recording system. In the water-soluble ink, since it is inferior in light fastness, the light fastness of a recorded image or letters is often of a problem. Also, since the ink is soluble in water, the water resistance of an image or letters is often of a problem. In order to solve these problems, a pigment ink is proposed as the ink to be used in the inkjet recording system in place of the water-soluble ink. Different from the water-soluble ink, in this pigment ink, the majority of a pigment remains on a medium to be recorded and forms an image or letters as a particle. For that reason, it is often pointed out that the pigment ink is inferior in fixability or glossy feeling especially on glossy paper.

In order to improve these problems, as a method for realizing an image with high fixability by using a pigment ink, JP-A-04-18461 (Patent Document 1) describes a method in which in addition to acidic carbon black, a water-soluble resin having an acid value of 250 or more is contained in an ink. However, according to the method described in Patent Document 1, when a large amount of the water-soluble resin is added such that the fixability is satisfied, an inconvenience that the discharge stability of the ink is remarkably hindered is generated, and it is difficult to make both the fixability and the discharge stability satisfactory at the same time. Moreover, when the ink is printed on glossy paper, it may be a cause for generating white darkening.

Also, as other method, JP-A-10-36726 (Patent Document 2) describes a method in which in addition to self-dispersible carbon black, a cationic polymer is contained in an ink. However, according to the method described in Patent Document 2, since the carbon black and the polymer having a different polarity from each other coexist, the carbon black is easily coagulated, and it is difficult to make the discharge stability satisfactory.

Also, Japanese Patent No. 3467831 (Patent Document 3) describes an ink containing a polymer fine particle for inkjet recording ink composed of a crosslinkable monomer, a hydrophilic monomer and other copolymerizable monomer in addition to a pigment. However, according to the ink described in Patent Document 3, it is difficult to make both the fixability of an image or letters and the discharge stability satisfactory at the same time.

In the light of the above, in the case of using a pigment ink, both the fixability and the discharge stability cannot be satisfied at the same time. In particular, in using a pigment ink on glossy paper, white darkening is generated; a glossy feeling is impaired; all of the fixability, discharge stability and glossy feeling are not satisfactory at the same time; and it is difficult to obtain an image or letters with a high grade.

### SUMMARY OF THE INVENTION

It is desirable to provide a recording liquid which has good fixability to a medium to be recorded without impairing the discharge stability, is free from the generation of white darkening and has excellent glossy feeling and in particular, excellent fixability and glossy feeling to glossy paper, a recording method using this recording liquid and a recording liquid cartridge.

The recording liquid according to an embodiment of the present invention is a recording liquid containing a pigment; a solvent for dissolving or dispersing this pigment therein and containing water and a water-soluble organic solvent; a water-soluble resin containing a sulfonated isoprene resin and an acrylic resin; and a surfactant containing a polyoxyethylene alkyl phenyl ether and/or a sulfuric ester salt thereof.

Also, the recording method according to an embodiment of the present invention is a recording method including the steps of pressurizing a recording liquid by a pressure-generating element and impacting the recording liquid on a medium to be recorded by a liquid discharge device for discharging it from discharge openings, the recording liquid containing a pigment; a solvent for dissolving or dispersing this pigment therein and containing water and a water-soluble organic solvent; a water-soluble resin containing a sulfonated isoprene resin and an acrylic resin; and a surfactant containing a polyoxyethylene alkyl phenyl ether and/or a sulfuric ester salt thereof.

Also, the recording liquid cartridge according to an embodiment of the present invention is a recording liquid cartridge having a recording liquid accommodated therein, the recording liquid containing a pigment; a solvent for dissolving or dispersing this pigment therein and containing water and a water-soluble organic solvent; a water-soluble resin containing a sulfonated isoprene resin and an acrylic resin; and a surfactant containing a polyoxyethylene alkyl phenyl ether and/or a sulfuric ester salt thereof.

According to an embodiment of the present invention, owing to the matter that a water-soluble resin containing a sulfonated isoprene resin and an acrylic resin is contained, a recording liquid which has good fixability to a medium to be recorded without impairing the discharge stability, is able to prevent the generation of white darkening caused due to the matter that the acrylic resin is contained by the action of a surfactant containing a polyoxyethylene alkyl phenyl ether and/or a sulfuric ester salt thereof and has excellent glossy feeling and in particular, excellent fixability and glossy feeling to glossy paper is obtained.

### BRIEF DESCRIPTION OF THE DRAWINGS

FIG. 1 is an exploded perspective view of a printer device to which an embodiment according to the present invention is applied.

FIG. 2 is an exploded perspective view of a head cartridge.

FIG. 3 is a cross-sectional view of the same head cartridge.

FIGS. 4A and 4B each shows an ink discharge head, in which FIG. 4A is a cross-sectional view schematically showing a state that an air bubble is generated on a heat-generating resistor, and FIG. 4B is a cross-sectional view schematically showing a state that an ink is discharged from a nozzle.

FIG. 5 is a perspective side view for explaining a printing operation of the same printer device.

### DETAILED DESCRIPTION OF THE PREFERRED EMBODIMENTS

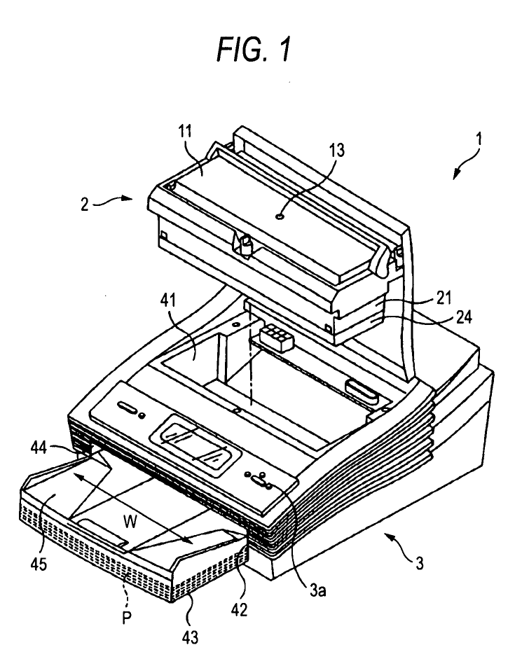

An ink, a printing method and an ink tank to each of which the present invention is applied are hereunder described with reference to the accompanying drawings. An ink i to which the present invention is applied is used in, for example, an inkjet printer device 1 (hereinafter referred to as “printer device 1”) as illustrated in FIG. 1. In this printer device 1, by using, for example, a black ink as the ink i and discharging this ink i on recording paper P, an image or letters can be printed on the recording paper P. The recording paper P is, for example, glossy paper. However, the recording paper P is not limited to this but may be plain paper or the like. In the following description, the ink i to which the present invention is applied is first described, and the printer device 1 as illustrated in FIG. 1 in which this ink i is used is then described.

The ink i contains a pigment; a solvent for dissolving or dispersing this pigment therein and containing water and a water-soluble organic solvent; a water-soluble resin containing a sulfonated isoprene resin and an acrylic resin; and a surfactant containing a polyoxyethylene alkyl phenyl ether and/or a sulfuric ester salt thereof. The ink i is one obtained by dispersing or dissolving a pigment, a water-soluble resin and a surfactant in an aqueous medium.

The pigment is one obtained by subjecting a pigment to a surface treatment such that at least one functional group of a carbonyl group, a carboxyl group, a hydroxyl group and a sulfone group or a salt thereof is bound on a surface thereof, and according to this surface treatment, the pigment is made dispersible in water without adding a dispersant in the ink i. Concretely, the pigment is one obtained by grafting a functional group or a functional group-containing molecule on a surface of carbon black by a physical treatment with vacuum plasma or the like or a chemical treatment. The functional group to be grafted on one carbon black particle may be single or plural. The kind and degree of the functional group to be grafted is properly determined while taking into consideration the dispersion stability and color density in the ink i and the dryness on a discharge face 23a of a head cartridge 2 as described later and the like. With respect to the pigment, a pigment having a carboxyl group on a surface thereof can be obtained by, for example, a method described in JP-A-8-3498.

As the pigment, commercially available products can also be used. Preferred examples thereof include self-dispersible carbon blacks such as MICROJET CW1 and CW2, manufactured by Orient Chemical Industries, Ltd. and CABOJET C-200 and C-300, manufactured by Cabot Corporation.

The content of the pigment contained in the ink i is preferably from 2% by mass to 15% by mass, and more preferably from 4% by mass to 10% by mass of the total mass of the ink i.

The solvent for dissolving or dispersing this pigment therein is, for example, water or a mixed solvent of water and a water-soluble organic solvent, and preferably a mixed solvent of water and a water-soluble organic solvent. The water-soluble organic solvent is preferably one having an effect for preventing drying of the ink i.

Examples of the water-soluble organic solvent include alkyl alcohols having from 1 to 4 carbon atoms such as methyl alcohol, ethyl alcohol, n-propyl alcohol, isopropyl alcohol, n-butyl alcohol, sec-butyl alcohol and tert-butyl alcohol; amides such as dimethylformamide and dimethylacetamide; ketones or keto alcohols such as acetone, methyl ethyl ketone, methyl isobutyl ketone and diacetone alcohol; ethers such as tetrahydrofuran and dioxane; polyalkylene glycols such as polyethylene glycol and polypropylene glycol; polyols in which an alkylene group thereof has from 2 to 6 carbon atoms, such as ethylene glycol, propylene glycol, butylenes glycol, pentanediol, triethylene glycol, 1,2,6-hexanetriol, thio-diglycol, hexylene glycol and diethylene glycol; lower alkyl ether acetates such as polyethylene glycol monomethyl ether acetate; glycerin; lower alkyl ethers of a polyhydric alcohol such as ethylene glycol monomethyl (or monoethyl) ether, diethylene glycol methyl (or ethyl) ether and triethylene glycol monomethyl (or monoethyl) ether; polyhydric alcohols such as trimethylolpropane and trimethylolethane; N-meth-yl-2-pyrrolidone; 2-pyrrolidone; and 1,3-dimeth-yl-2-imidazolidinone. These organic solvents can be used singly or as a mixture obtained by mixing plural kinds thereof. Deionized water is preferably used as the water.

The content of the water-soluble organic solvent is not particularly limited and is preferably in the range of from 3% by mass to 50% by mass of the total mass of the ink i. The content of water to be contained in the ink i is preferably in the range of from 50% by mass to 95% by mass of the total mass of the ink i.

The water-soluble resin in the ink i is a sulfonated isoprene resin and an acrylic resin. Both the sulfonated isoprene resin and the acrylic resin enhance the fixability of the ink i to the recording paper P. In the case where the sulfonated isoprene resin or the acrylic resin is contained singly in the ink i, in order that the fixability may be satisfied, the content of such a resin to be contained in the ink i becomes high. When the content of the resin is increased to an extent that the fixability is satisfied, the discharge stability becomes worse, and it is difficult to make both the fixability and the discharge stability compatible with each other. Also, the acrylic resin easily causes white darkening of an image or letters and impairs a glossy feeling, leading to causing a reduction of the grade. Thus, its use is limited. Accordingly, in the ink i, by using jointly the sulfonated isoprene resin and the acrylic resin, the fixability is obtained, and a reduction of the discharge stability and the generation of white darkening can be prevented without increasing the content of these resins.

Concretely, the sulfonated isoprene resin is preferably one obtained by alkaline neutralization, and examples thereof include ones obtained by alkaline neutralization with an alkali metal (for example, Na, Li and K) or an organic ammonium. Examples of the organic ammonium include methylammonium, dimethylammonium, trimethylammonium, ethylammonium, diethylammonium, triethylammonium, trihydroxymethylamine, dihydroxymethylamine, monohydroxymethylamine, monoethanol-ammonium, diethanolammonium, triethanolammonium, N-methyl-monoethanolammonium, N-methyldiethanolammonium, mono-propanolammonium, dipropanolammonium and tripropanolammonium. Examples of commercially available sulfonated isoprene resins include DYNAFLOW K201, manufactured by JSR Corporation.

Similar to the sulfonated isoprene resin, examples of the acrylic resin include ones obtained by alkaline neutralization with the foregoing neutralizing agent. Specific examples of the acrylic resin include polyacrylic acid, polymethacrylic acid, (meth)acrylic acid-(meth)acrylic alkyl ester copolymers, (meth)acrylic acid-maleic half ester copolymers, (meth)acrylic acid-maleic dialkyl ester copolymers, styrene-(meth)acrylic acid copolymers and styrene-(meth)acrylic acid-(meth)acrylic alkyl ester copolymers. Examples of commercially available acrylic resins include JONCRYL 680, manufactured by Johnson Polymer, Inc.

For the purpose of obtaining good fixability of an image or letters without impairing the discharge stability, the content of each of the sulfonated isoprene resin and the acrylic resin is from 0.5% by mass to 2.0% by mass of the total mass of the ink i. When the content of each of the sulfonated isoprene resin and the acrylic resin is 0.5% by mass or more, the fixability of an image or letters becomes good, and when it is not more than 2.0% by mass, sufficient fixability of an image or letters can be obtained without impairing the discharge stability.

The ink i can also contain other water-soluble resin in addition to the sulfonated isoprene resin and the acrylic resin.

The surfactant in the ink i is able to prevent a reduction of the glossy feeling caused due to white darkening of an image or letters on glossy paper, which is easily generated by the addition of the acrylic resin in the ink i. The surfactant is a polyoxyethylene alkyl phenyl ether and/or a sulfuric ester salt thereof, and especially preferably a polyoxyethylene distyrenated phenyl ether and/or a sulfuric ester salt thereof. This polyoxyethylene alkyl phenyl ether and/or its sulfuric ester salt has good compatibility with carbon black as a pigment.

Owing to the matter that the ink i contains the foregoing sulfonated isoprene resin and acrylic resin as a water-soluble resin and the foregoing polyoxyethylene alkyl phenyl ether and/or its sulfuric ester salt as a surfactant, the fixability to the recording paper P and the glossy feeling of the resulting image or letters are excellent without impairing the discharge stability, and all of the discharge stability, fixability and glossy feeling can be satisfied. With respect to the reasons why the excellent glossy feeling is obtained, it is thought that owing to the matter that the surfactant is contained in the ink i, the penetration of the acrylic resin which has been unable to penetrate into the inside of the recording paper P and remained on the surface of the recording paper P is promoted, or a resin film is uniformly formed. In using the polyoxyethylene alkyl phenyl ether and/or its sulfuric ester salt, the generation of white darkening of an image or letters cannot be prevented, and an effect for preventing a reduction of the glossy feeling is not recognized.

For the purpose of preventing the generation of white darkening caused due to the matter that the acrylic resin is contained in the ink i, the content of the polyoxyethylene alkyl phenyl ether and/or its sulfuric ester salt as a surfactant is from 0.5% by mass to 4.0% by mass, and preferably from 1.0% by mass to 3.0% by mass of the total mass of the ink i. So far as the content of the polyoxyethylene alkyl phenyl ether and/or its sulfuric ester salt is in the range of from 0.5% by mass to 4.0% by mass, the generation of white darkening can be prevented, an excellent glossy feeling is obtained, and the generation of a fault caused due to the matter that the surfactant is contained can be prevented.

The ink i can also contain other surfactant in addition to the polyoxyethylene alkyl phenyl ether and/or its sulfuric ester salt.

Furthermore, in the ink i, in addition to the pigment, the water-soluble resin and the surfactant, for the purpose of forming an ink having desired physical properties, an anti-foaming agent, an antiseptic, an antifungal agent, a pH modifier, an antioxidant and the like may be added as the need arises.

Since the ink i having the foregoing constitution is discharged from a fine nozzle of the inkjet printer device 1 as described later, it is preferable that the ink i has such a characteristic that it can be discharged from this nozzle. From the viewpoint of discharge properties from the nozzle, with respect to the characteristic of the ink i, for example, it is preferable that the ink i has a viscosity of from 1 cPs to 15 cPs and a surface tension of 25 dyn/cm or more. In particular, it is more preferable that the ink i has a viscosity of from 1 cPs to 5 cPS and a surface tension of from 25 dyn/cm to 50 dyn/cm.

In the ink i having the foregoing constitution, owing to the matter that in addition to the pigment, the sulfonated isoprene resin and the acrylic resin as a water-soluble resin and the polyoxyethylene alkyl phenyl ether and/or its sulfuric eater salt as a surfactant are contained in the solvent, the fixability of an image to be brought by the water-soluble resin is obtained without impairing the discharge stability; the generation of white darkening of an image or letters caused due to the surfactant can be prevented; and an image or letters with a high grade which is excellent in all of the discharge stability, fixability and glossy feeling can be formed.

With respect to the foregoing ink i, the black ink using carbon black as a pigment has been described. However, the present invention is not limited to this. The ink may be a yellow ink, a magenta ink or a cyan ink using a pigment of a yellow, magenta or cyan color, respectively.

The foregoing ink i is used in the printer device 1 as illustrated in FIG. 1. The printer device 1 is provided with an inkjet printer head cartridge (hereinafter referred to as “head cartridge”) 2 which makes a liquid discharge head for discharging the foregoing ink i onto the recording paper P and a device main body 3 in which this head cartridge 2 is installed. This printer device 1 is a so-called line type printer device in which nozzles are juxtaposed in a substantially line state in a width direction of the recording paper P, namely in an arrow W direction in FIG. 1. In the printer device 1, the head cartridge 2 is detachable to the device main body 3. In the printer device 1, though the head cartridge 2 is detachable to the device main body 3, the head cartridge 2 may be fixed to the device main body 3.

Different from a serial type printer device in which the head cartridge 2 moves in the width direction of the recording paper P, in this line type printer device 1, since the head cartridge 2 does not move in the width direction and the ink i is discharged for every nozzle line, a discharge interval is short. Even in the case of such a line type printer device, owing to the matter that the sulfonated isoprene resin and the acrylic resin as a water-soluble resin and the polyoxyethylene alkyl phenyl ether and/or its sulfuric ester salt as a surfactant are contained in the ink i to be used, clogging of the nozzle is not generated, and even when the discharge interval is short, the discharge stability is excellent.

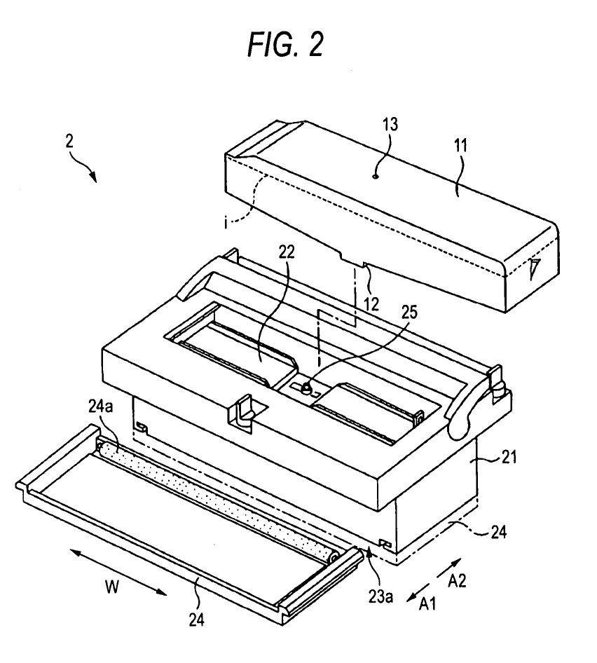

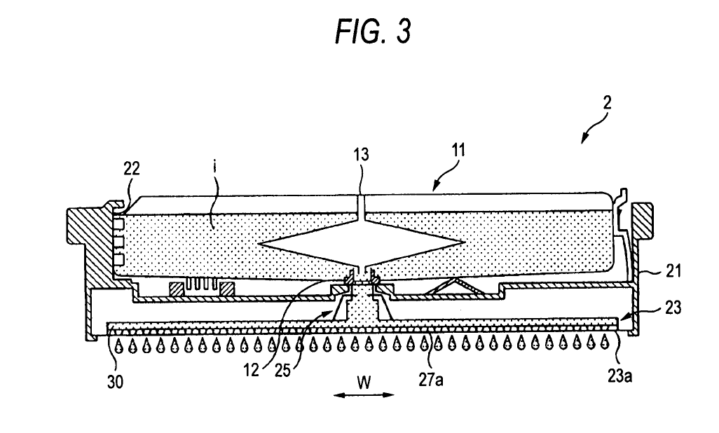

First of all, the head cartridge 2 for discharging the ink i is described. The head cartridge 2 discharges the foregoing ink i by a pressure generated by, for example, a pressure-generating unit employing an electro-thermal conversion type and impacts the ink i on a principal face of the recording paper P. As illustrated in FIGS. 2 and 3, an ink tank 11 which makes a recording liquid cartridge as a container having the ink i filled therein is installed in the head cartridge 2. The ink tank 11 is formed in a substantially rectangular shape having substantially the same size as the size in the width direction of the recording paper P. Concretely, the ink tank 11 is provided with an ink feed part 12 for feeding the ink i into a cartridge main body 21 of the head cartridge 2, and an external communicating hole 13 for taking in air from the outside after the ink i has been fed into the cartridge main body 21 is provided in substantially the center on an upper face thereof.

The ink feed part 12 is provided in a substantially central part in the lower side of the ink tank 11. This ink feed part 12 is a nozzle having a substantially projected shape, and when a tip of this nozzle is interfitted in a connection part 25 of the head cartridge 2 as described later, the ink tank 11 and the cartridge main body 21 of the head cartridge 2 are connected to each other such that the ink can be fed. The ink feed part 12 is provided with a valve mechanism, and the feed of the ink i into the cartridge main body 21 is adjusted by this valve mechanism. In addition to the foregoing configuration, the ink tank 11 may be provided with, for example, a residual quantity detecting part for detecting the residual quantity of the ink i. The ink tank 11 may be integrally formed with the head cartridge 2.

As illustrated in FIGS. 2 and 3, the head cartridge 2 in which the ink tank 11 is installed has the cartridge main body 21. The cartridge main body 21 is provided with an installation part 22 in which the ink tank 11 is installed, a discharge head 23 for discharging the ink i and a head cap 24 for protecting the ink discharge head 23.

The installation part 22 in which the ink tank 11 is installed is formed in substantially a recess shape. In the installation part 22, the connection part 25 to be connected to the ink feed part 12 of the ink tank 11 as installed is provided in substantially the center thereof. This connection part 25 makes an ink feed passage for feeding the ink i from the ink feed part 12 of the ink tank 11 installed in the installation part 22 into the ink discharge head 23 for discharging the ink i as provided on the bottom face of the cartridge main body 21. In the connection part 25, the feed of the ink i from the ink tank 11 into the ink discharge head 23 is adjusted by a valve mechanism.

The ink discharge head 23 into which the ink i is fed from the connection part 25 is arranged along the bottom face of the cartridge main body 21. In the ink discharge head 23, nozzles 27a as described later, each of which is a discharge opening for discharging the ink i fed from the connection part 25, are juxtaposed in a substantially line state in the width direction of the recording paper P, namely in the arrow W direction in FIG. 3. In discharging the ink i, the ink discharge head 23 discharges the ink i in every nozzle line without being moved in the width direction of the recording paper P.

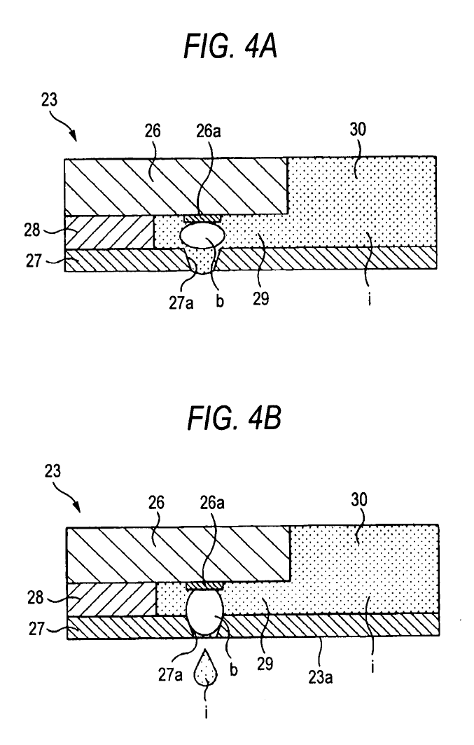

As illustrated in FIGS. 4A and 4B, the ink discharge head 23 is formed of a circuit board 26 provided with a heat-generating resistor 26a of an electro-thermal conversion type, a nozzle sheet 27 having the nozzles 27a formed therein and a film 28 provided between the circuit board 26 and the nozzle sheet 27. In the ink discharge head 23, an ink liquid compartment 29 which is surrounded by the circuit board 26, the nozzle sheet 27 and the film 28 is formed. The ink liquid compartment 29 is filled with the ink i to be heated by the heat-generating resistor 26a. Also, an ink passage 30 for feeding the ink i from the ink tank 11 having the ink i accommodated therein into the ink liquid compartment 29 is formed in the ink discharge head 23. In the ink discharge head 23, the circuit boards 26 are juxtaposed in a staggered state while interposing the ink passage 30 therebetween; and the nozzles 27a are juxtaposed in a position opposing to the heat-generating resistors 26a provided in the juxtaposed circuit boards 26. In the ink discharge head 23, even in an easy structure in which the circuit boards 26 are arranged in a staggered state, it is possible to print an image or letters with a high grade.

In the ink discharge head 23 having the foregoing configuration, a control circuit of the circuit board 26 is controlled by a recording signal on a basis of printing data, and a pulse current is fed into the selected heat-generating resistor 26a, thereby heating the heat-generating resistor 26a. In the ink discharge head 23, when the heat-generating resistor 26a is heated, as illustrated in FIG. 4A, an air bubble b is formed in the ink i coming into contact with the heat-generating resistor 26a. Then, in the ink discharge head 23, as illustrated in FIG. 4B, the air bubble b pressurizes the ink i while being expanded, and the ink i thus pushed away becomes in a droplet state and is discharged from the nozzle 27a. After discharging the droplet of the ink i, the ink discharge head 23 is again returned to an original state before discharging by feeding the ink i into the ink liquid compartment 29 through the ink passage 30. The ink discharge head 23 repeats the foregoing operations by a recording signal on a basis of printing data and discharges the ink i onto the recording paper P, thereby printing an image or letters.

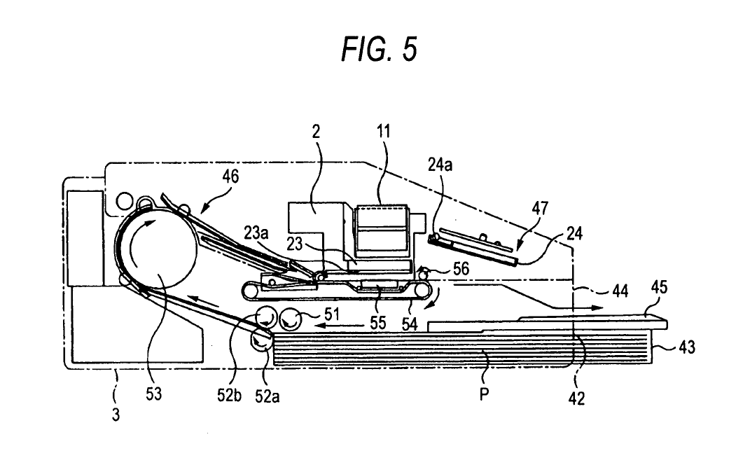

As illustrated in FIG. 2, during a period of time when the ink i is not discharged and printing is not performed, the head cap 24 for protecting the discharge face 23a of the ink discharge head 23 closes the discharge face 23a of the ink discharge head 23, thereby protecting the nozzle 27a from drying or the like. As illustrated in FIGS. 2 and 5, in performing printing, the head cap 24 moves from the bottom face of the head cartridge 2 into a front side of the device main body 3, namely in an arrow A1 direction in FIG. 2 and exposes the discharge face 23a of the ink discharge head 23 to the outside. After the printing has been finished, as illustrated in FIG. 2, the head cap 24 moves from the front side of the device main body 3 into the bottom face of the head cartridge 2, namely in an arrow A2 direction in FIG. 2 and protects the discharge face 23a of the ink discharge head 23.

This head cap 24 is provided with a cleaning roller 24a for wiping out the excess of the ink i attached to the discharge face 23a. In the head cap 24, in leaving the discharge face 23a open, the discharge face 23a is cleaned up by the cleaning roller 24a, thereby absorbing the excess of the ink i attached to the discharge face 23a. After printing, in moving the head cap 24 into the bottom face of the heat cartridge 2, there may be the case where the discharge face 23a is cleaned up by the cleaning roller 24a.

As illustrated in FIG. 1, in the device main body 3 in which the head cartridge 2 is installed, the head cartridge 2 is installed in a head cartridge installation part 41. The device main body 3 is mounted with a paper feed tray 43 in which recording papers P prior to printing are stacked and accommodated in a paper feed port 42 provided in a lower side of a front face thereof and mounted with a paper discharge tray 45 for accommodating the recording papers P after printing in a paper discharge port 44 provided in an upper side of the front face.

As illustrated in FIG. 5, the device main body 3 is provided with a paper feed and discharge mechanism 46 for conveying the recording paper P and a head cap opening and closing mechanism 47 for opening and closing the head cap 24 provided on the discharge face 23a of the head cartridge 23.

The printer device 1 having the foregoing configuration performs printing on a basis of printing data inputted from an externally provided information processor. That is, in the printer device 1, the head cap 24 is moved into the front face side of the device main body 3 provided with the paper feed tray 43 and the paper discharge tray 45 relative to the head cartridge 2 by the head cap opening and closing mechanism 47. According to this, in the printer device 1, each of the nozzles 27a provided on the discharge face 23a of the ink discharge head 23 is exposed to the outside, whereby it is able to discharge the ink i.

Next, in the printer device 1, the paper feed and discharge mechanism 46 of the device main body 3 is driven by the operation of an operation button 3a provided in the device main body 3; the recording paper P is drawn out from the paper feed tray 43 by a paper feed roller 51; and only one sheet of the recording paper P is drawn out from the paper feed tray 43 by a pair of separation rollers 52a, 52b rotating in the same direction. In the printer device 1, the recording paper P drawn out from the paper feed tray 43 is reversed towards the side of the discharge head 23 by a reverse roller 53, and the recording paper P is then conveyed onto a conveyance belt 54 provided in a position opposing to the discharge face 23a. The recording paper P is held by a platen plate 55 provided in a position opposing to the discharge face 23a of the ink discharge head 23, whereby the recording paper P is made opposite to the discharge face 23a.

Next, in the printer device 1, a driving current is fed into the plural heat-generating resistors 26a provided for every color in the ink discharge head 23 on a basis of a control signal of printing data, thereby heating the heat-generating resistors 26a. In the printer device 1, as illustrated in FIGS. 4A and 4B, the foregoing ink i is discharged in a droplet state from the nozzles 27a onto the recording paper P conveyed in a position opposing to the discharge face 23a, thereby printing an images or letters.

Then, in the printer device 1, when the droplet of the ink i is discharged from the nozzle 27a, the ink i of the same amount as the discharged amount of the ink i is fed into the ink discharge head 23 from the ink tank 11 via the connection part 25.

Next, in the printer device 1, the recording paper P in which printing has been finished is sent out by the conveyance belt 54 rotating in a direction of the paper discharge port 44 and a paper discharge roller 56 opposing to the conveyance belt 54 and provided in a side of the paper discharge port 44 relative to the discharge face 23a, whereby the recording paper P after printing is discharged into the paper discharge tray 45. In the printer device 1, printing of an image or letters is carried out on the recording paper P in this manner.

In the printer device 1 having the foregoing configuration, owing to the matter that in addition to the pigment, the sulfonated isoprene resin and the acrylic resin as a water-soluble resin and the polyoxyethylene alkyl phenyl ether and/or its sulfuric ester salt as a surfactant are contained in the ink i, the fixability of an image or letters by the water-soluble resin is obtained without impairing the discharge stability of the nozzle 27a, the generation of white darkening of an image or letters by the surfactant can be prevented, and an image or letters with an excellent glossy feeling can be printed. According to this, in the printer device 1, all of the discharge stability of the ink i and the fixability and glossy feeling of the image can be made excellent, and an image or letters with a high grade can be printed.

While the case of using glossy paper as the recording paper P has been described, it should not be construed that the present invention is limited thereto. An image or letters of the same high grade can be obtained even by performing printing using the ink i on other recording paper P such as plain paper.

In the foregoing printer device 1, though a black ink is used as the ink i, color printing using four color inks may also be performed by preparing ink tanks accommodating therein a yellow ink, a magenta ink and a cyan ink, respectively.

Also, the foregoing ink i can be applied to not only an electro-thermal conversion system for discharging it in a droplet state from the nozzle 27a upon being heated by the heat-generating resistor 26a as in the printer device 1 but a recording system, for example, a piezoelectric system for flying fine droplets by utilizing vibration of a piezoelectric element (for example, JP-A-55-65559, JP-A-62-160243 and JP-A-2-270561), whereby the same effects as those described above are obtained.

Also, while the line type printer device 1 has been described as an example, it should not be construed that the present invention is limited thereto. For example, the present invention is also applicable to a serial type printer device in which the head cartridge moves in a direction substantially perpendicular to the running direction of the recording paper P.

### EXAMPLES

Examples and Comparative Examples in which an ink to which the present invention is applied was prepared are hereunder described. The units are % by mass unless otherwise indicated. It should not be construed that the invention is limited thereto.

### Example 1

In Example 1, 4% by mass of a trade name, CABOJET C-300 (manufactured by Cabot Corporation) as a pigment, 10% by mass of 2-pyrrolidone and 8% by mass of propanediol as a solvent, 1% by mass of a trade name, JONCRYL 680 (an NaOH-neutralized product, manufactured by Johnson Polymer, Inc.) as a acrylic resin, 1% by mass of a trade name, DYNAFLOW K201 (manufactured by JSR Corporation) as a sulfonated isoprene resin, 2% by mass of a trade name, HITENOL NF-17 (manufactured by Dai-ichi Kogyo Seiyaku Co., Ltd.) as a polyoxyethylene distyrenated phenyl ether sulfuric ester salt and 74% by mass of purified water were well mixed and stirred for about 2 hours, and the mixture was then filtered by a membrane filter of 1.2 μm to prepare an ink.

### Examples 2 to 9

In Examples 2 to 9, inks were prepared in the same manner as in Example 1, except that in Example 1, the content of the acrylic resin, the content of the sulfonated isoprene resin, the kind and content of the polyoxyethylene distyrenated phenyl ether and/or its sulfuric ester salt and the content of the purified water were changed as shown in Table 1. EMULGEN A-60 and EMULGEN A-90 shown as the surfactant in Table 1, both of which are a trade name of Kao Corporation, are a polyoxyethylene distyrenated phenyl ether.

### Comparative Examples 1 to 5

In Comparative Examples 1 to 5, inks were prepared in the same manner as in Example 1, except that in Example 1, the content of the acrylic resin, the content of the sulfonated isoprene resin, the kind and content of the polyoxyethylene distyrenated phenyl ether and/or its sulfuric ester salt and the content of the purified water were changed as shown in Table 1.

A composition of each of the inks of Examples 1 to 9 and Comparative Examples 1 to 5 is shown in the following Table 1.

TABLE 1

| Ink composition | | Example | | | | | | | | | Comparative Example | | | | |
|---|---|---|---|---|---|---|---|---|---|---|---|---|---|---|---|
| (% by mass) | | 1 | 2 | 3 | 4 | 5 | 6 | 7 | 8 | 9 | 1 | 2 | 3 | 4 | 5 |
| Pigment | CABOJET C-300, | 4 | 4 | 4 | 4 | 4 | 4 | 4 | 4 | 4 | 4 | 4 | 4 | 4 | 4 |
| | manufactured by Cabot | | | | | | | | | | | | | | |
| | Corporation | | | | | | | | | | | | | | |
| Solvent | 2-Pyrrolidone | 10 | 10 | 10 | 10 | 10 | 10 | 10 | 10 | 10 | 10 | 10 | 10 | 10 | 10 |
| | Propanediol | 8 | 8 | 8 | 8 | 8 | 8 | 8 | 8 | 8 | 8 | 8 | 8 | 8 | 8 |
| Acrylic resin | JONCRYL 680, | 1 | 1 | 1 | 1 | 1 | 0.5 | 2 | 1 | 1 | 2.5 | | | 2.5 | |
| | manufactured by Johnson | | | | | | | | | | | | | | |
| | Polymer, Inc. | | | | | | | | | | | | | | |
| | (NaOH-neutralized product) | | | | | | | | | | | | | | |
| Sulfonated | DYNAFLOW K201, | 1 | 0.5 | 1 | 1.5 | 1 | 2 | 1 | 1 | 1 | | 2.5 | | | 2.5 |
| isoprene resin | manufactured by JSR | | | | | | | | | | | | | | |
| | Corporation | | | | | | | | | | | | | | |
| Polyoxyethylene | HITANOL NF-17, | 2 | | | | | | | | | | | | | |
| distyrenated | manufactured by | | | | | | | | | | | | | | |
| phenyl ether | Dai-ichi Kogyo | | | | | | | | | | | | | | |
| and/or its | Seiyaku Co., Ltd. | | | | | | | | | | | | | | |
| sulfuric ester | EMULGEN A-60, | | 1.5 | 1.5 | 1.5 | | 1.5 | 1.5 | 0.5 | 4 | 1.5 | 1.5 | 1.5 | | |
| salt | manufactured by | | | | | | | | | | | | | | |
| | Kao Corporation | | | | | | | | | | | | | | |
| | EMULGEN A-90, | | | | | 1.5 | | | | | | | | | |
| | manufactured by | | | | | | | | | | | | | | |
| | Kao Corporation | | | | | | | | | | | | | | |

| | | | | | | | | | | | | | | |
|---|---|---|---|---|---|---|---|---|---|---|---|---|---|---|
| Purified water | 74 | 75 | 74.5 | 74 | 74.5 | 74 | 73.5 | 75.5 | 72 | 74 | 74 | 76.5 | 75.5 | 75.5 |
| Total | 100 | 100 | 100 | 100 | 100 | 100 | 100 | 100 | 100 | 100 | 100 | 100 | 100 | 100 |

Each of the inks of Examples 1 to 9 and Comparative Examples 1 to 5 was evaluated with respect to the fixability, white darkening and nozzle clogging. The evaluation results are shown in Table 2.

TABLE 2

| | Example | | | | | | | | | Comparative Example | | | | |
|---|---|---|---|---|---|---|---|---|---|---|---|---|---|---|
| | 1 | 2 | 3 | 4 | 5 | 6 | 7 | 8 | 9 | 1 | 2 | 3 | 4 | 5 |
| Fixability | A | B | A | A | A | B | A | A | B | B | B | C | B | B |
| White darkening | A | A | A | A | A | A | B | B | A | C | A | A | C | A |
| Nozzle clogging | A | A | A | A | A | A | A | A | A | B | B | A | B | B |

The fixability, white darkening and nozzle clogging as shown in Table 2 were evaluated in the following manners. First of all, a head cartridge integrated with an ink tank was removed from a main body of a printer device of the foregoing line type (having a line head of an A4 size width and a resolution of 600 dpi), and each of the inks of the Examples and Comparative Examples was filled in the ink tank. Next, photographic glossy paper manufactured by Sony Corporation (EPP-20A4GB) was used as a medium to be recorded, and this photographic glossy paper was subjected to monochromic solid printing.

In the evaluation of the fixability, a printed portion obtained by monochromic solid printing was rubbed for 5 reciprocations (40 reciprocations per minute) under a load of 200 g by using BEMCOAT (M-3, manufactured by Asahi Kasei Corporation) in the contact portion by a rubbing tester for color fastness, RT-200S (manufactured by Daiei Kagaku Seiki Mfg. Co., Ltd.), and a reflection optical density of the monochromic solid printed portion was measured before and after the test by a reflection densitometer, Macbeth TR924, manufactured by Gretag Macbeth. In the evaluation of the fixability, the case where a reduction of the density is not observed is expressed by an “A” mark; the case where a residual rate [=(density after the test)/(density before the test)×100] is 80% or more is expressed by a “B” mark; and the case where the residual rate is less than 80% is expressed by a “C” mark, respectively in Table 2.

With respect to the evaluation of the white darkening, similar to the evaluation of the fixability, photographic glossy paper manufactured by Sony Corporation (EPP-20A4GB) was subjected to monochromic solid printing by a printer device of the foregoing line type. The degree of white darkening of the monochromic solid printed portion was visually judged. In the evaluation of the white darkening, the case where no white darkening is observed is expressed by an “A” mark; the case where white darkening is slightly observed is expressed by a “B” mark; and the case where white darkening is observed and a glossy feeling is remarkably lowered is expressed by a “C” mark, respectively in Table 2.

With respect to the evaluation of the nozzle clogging, similar to the evaluation of the fixability, photographic glossy paper manufactured by Sony Corporation (EPP-20A4GB) was subjected to monochromic solid printing by a printer device of the foregoing line type. The printed state of the monochromic solid printed portion was visually judged. In the evaluation of the nozzle clogging, the case where the printed state is good is expressed by an “A” mark; the case where a blur is observed is expressed by a “B” mark; and the case where the printing cannot be achieved at all is expressed by a “C” mark, respectively in Table 2.

As is clear from the results as shown in Table 2, Examples 1 to 9 were good in all of the fixability, white darkening and nozzle clogging as compared with Comparative Examples 1 to 5.

In Comparative Example 1, since the sulfonated isoprene resin is not contained and the content of the acrylic resin is 2.5% by mass, white darkening was generated in the monochromic solid printed portion, and the evaluation in all of the fixability, white darkening and nozzle clogging was not satisfactory.

In Comparative Example 2, since the acrylic resin is not contained and the content of the sulfonated isoprene resin is 2.5% by mass, the fixability of the monochromic solid printed portion was poor, and nozzle clogging was also generated.

In Comparative Example 3, since both the acrylic resin and the sulfonated isoprene resin are not contained, the fixability of the monochromic solid printed portion was poor, and the evaluation in all of the fixability, white darkening and nozzle clogging was not satisfactory.

In Comparative Example 4, since the sulfonated isoprene resin is not contained and the polyoxyethylene distyrenated phenyl ether or its sulfuric ester salt as a surfactant is not contained, white darkening was generated in the monochromic solid printed portion, and the evaluation in all of the fixability, white darkening and nozzle clogging was not satisfactory.

In Comparative Example 5, since the acrylic resin is not contained and the polyoxyethylene distyrenated phenyl ether or its sulfuric ester salt as a surfactant is not contained, the fixability of the monochromic solid printed portion was poor, and nozzle clogging was also generated.

It is understood from the foregoing Comparative Examples 1 to 5 that in the case where either one of the sulfonated isoprene resin or the acrylic resin is contained or the both are not contained, both the fixability and the nozzle clogging are not satisfactory at the same time. Also, it is understood from Comparative Examples 1 to 5 that in the case where the polyoxyethylene distyrenated phenyl ether or its sulfuric ester salt as a surfactant is not contained, the generation of white darkening in the printed portion cannot be prevented.

In contrast to these Comparative Examples, in Examples 1 to 9, since all of the acrylic resin, the sulfonated isoprene resin and the polyoxyethylene distyrenated phenyl ether or its sulfuric ester salt are contained in adequate amounts in the ink, monochromic solid printed materials which not only have sufficient fixability without causing nozzle clogging but are free from white darkening in a monochromic solid printed portion due to the surfactant and have a good grade with a glossy feeling are obtained.

It is understood from the foregoing Examples 1 to 9 that owing to the matter that the acrylic resin, the sulfonated isoprene resin and the polyoxyethylene distyrenated phenyl ether or its sulfuric ester salt are contained in the ink, all of the fixability, white darkening and nozzle clogging are satisfactory.

It should be understood by those skilled in the art that various modifications, combinations, sub-combinations and alternations may occur depending on design requirements and other factors insofar as they are within the scope of the appended claims or the equivalents thereof.

What is claimed is:

1. A recording liquid comprising:
a pigment;
a solvent for dissolving or dispersing this pigment therein and containing water and a water-soluble organic solvent;
a water-soluble resin containing a sulfonated isoprene resin and an acrylic resin; and
a surfactant containing a polyoxyethylene alkyl phenyl ether and/or a sulfuric ester salt thereof.

2. The recording liquid according to claim 1, wherein
the pigment is self-dispersible carbon black.

3. The recording liquid according to claim 1, wherein
the content of the sulfonated isoprene resin is from 0.5% by mass to 2.0% by mass of the total mass.

4. The recording liquid according to claim 1, wherein
the content of the acrylic resin is from 0.5% by mass to 2.0% by mass of the total mass.

5. The recording liquid according to claim 1, wherein
the surfactant is a polyoxyethylene distyrenated phenyl ether and/or a sulfuric ester salt thereof.

6. The recording liquid according to claim 1, wherein
the content of the surfactant is from 0.5% by mass to 4.0% by mass of the total mass.

7. A recording method including the steps of:
pressurizing a recording liquid by a pressure-generating element; and
impacting the recording liquid on a medium to be recorded by a liquid discharge device for discharging it from discharge openings,
the recording liquid containing a pigment; a solvent for dissolving or dispersing this pigment therein and containing water and a water-soluble organic solvent; a water-soluble resin containing a sulfonated isoprene resin and an acrylic resin; and a surfactant containing a polyoxyethylene alkyl phenyl ether and/or a sulfuric ester salt thereof.

8. The recording method according to claim 7, wherein
the pigment in the recording liquid is self-dispersible carbon black.

9. The recording method according to claim 7, wherein
the content of the sulfonated isoprene resin is from 0.5% by mass to 2.0% by mass of the total mass.

10. The recording method according to claim 7, wherein
the content of the acrylic resin is from 0.5% by mass to 2.0% by mass of the total mass.

11. The recording method according to claim 7, wherein
the surfactant is a polyoxyethylene distyrenated phenyl ether and/or a sulfuric ester salt thereof.

12. The recording method according to claim 7, wherein
the content of the surfactant is from 0.5% by mass to 4.0% by mass of the total mass.

13. The recording method according to claim 7, wherein
the discharge openings are juxtaposed in a width direction of the medium to be recorded in the liquid discharge device.

14. A recording liquid cartridge having a recording liquid accommodated therein,
the recording liquid containing a pigment; a solvent for dissolving or dispersing this pigment therein and containing water and a water-soluble organic solvent; a water-soluble resin containing a sulfonated isoprene resin and an acrylic resin; and a surfactant containing a polyoxyethylene alkyl phenyl ether and/or a sulfuric ester salt thereof.
